(19) United States
(12) Patent Application Publication
(10) Pub. No.: US 2016/0117523 A1
(43) Pub. Date: Apr. 28, 2016

(54) System and Method for Selectively Sharing Information

(71) Applicant: APPLIED RESEARCH WORKS, INC., Palo Alto, CA (US)

(72) Inventors: Shaibal Roy, Palo Alto, CA (US); Yin Ling Leung, Palo Alto, CA (US); Anandini Wadera, San Mateo, CA (US); Joyce Lignell, Honolulu, HI (US)

(21) Appl. No.: 14/521,705

(22) Filed: Oct. 23, 2014

(51) Int. Cl. G06F 21/62; H04L 29/06

(52) U.S. Cl. CPC G06F 21/6245; H04L 63/102

(57) ABSTRACT

Disclosed is a system and method for selectively sharing information among users of a computer application. Specific utility in healthcare applications is disclosed, but the scope of the invention is not limited to healthcare applications. The method involves selecting specific users, with whom information will be shared, a method for selecting such users' restrictions on the information that can be accessed by such users. Also disclosed is a system and method through which certain users can transmit communications on behalf of other users.

### PRIORITY CLAIM

This application is a continuation of, and claims the benefit of U.S. application Ser. No. 13/686,729 filed on Nov. 27, 2012. The aforementioned application is hereby incorporated by reference.

### BACKGROUND

In various computer applications, it is desirable to share information among numerous users. Although often times desirable, there are numerous instances in which it is necessary to share information only selectively. In healthcare, laws and regulations pertaining to privacy necessitate a means to share information among a carefully selected group of individuals. Even among those with whom information is shared, it is often times advantageous to share only certain, non-sensitive information with certain individuals. Due to privacy concerns, a system and method for selectively sharing information in industries such as healthcare is advantageous and necessary. In addition to healthcare, such a system and method would have utility in other applications such as social networking, financial transactions, and other applications where privacy is desirable.

### BRIEF SUMMARY

Disclosed is a system and method for selectively sharing information. Certain embodiments have utility in social networking, business, computer, financial, and healthcare applications.

The disclosed system will detect and suggest those who should be added to a circle. A circle is a group of users who have access to a primary user's account information. Access by circle members may be restricted by varying access levels selected by the primary user.

The disclosed system will detect and suggest users to be added to a circle based on similarities in account data. In healthcare applications, a subscriber ID, supplied by a health insurance provider, has particular utility in locating close relatives.

Among primary users who are unable to have an account of their own, a primary contact may be designated. The primary contact will typically be a parent or guardian when the primary user is a child. Alternatively, the primary contact can be another user in the case of an incapacitated adult.

The disclosed system and method has particular utility in healthcare. Certain embodiments of the disclosed invention enable friends and relatives of a primary user to access a primary user's medical information. In some instances, the disclosed system will enable a member of a primary user's circle to consent to medical procedures on behalf of the primary user.

### BRIEF DESCRIPTION OF THE DRAWINGS

FIG. 1 illustrates an embodiment of a system, including third parties, wherein some third parties are healthcare providers.

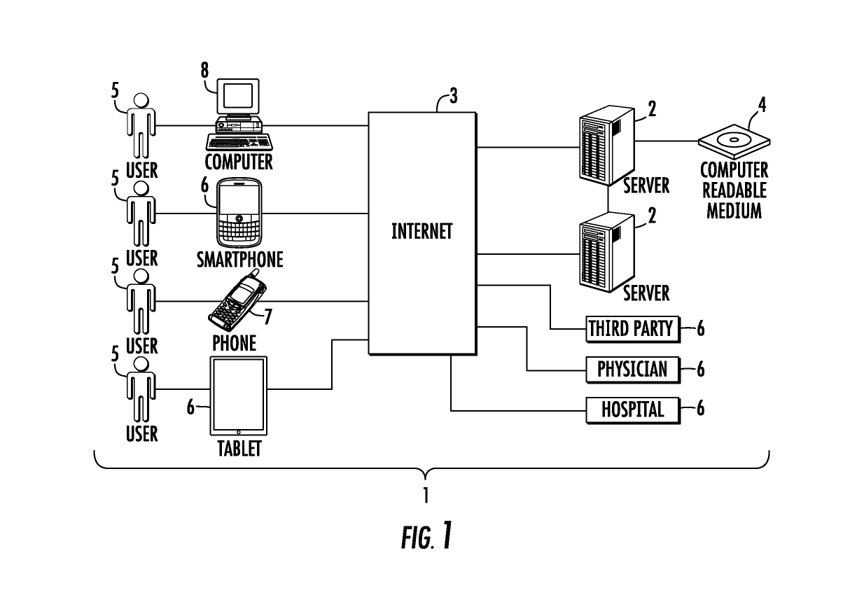

FIG. 2 illustrates an embodiment of a user interface wherein a primary user can select other users to become members of the primary user's circle.

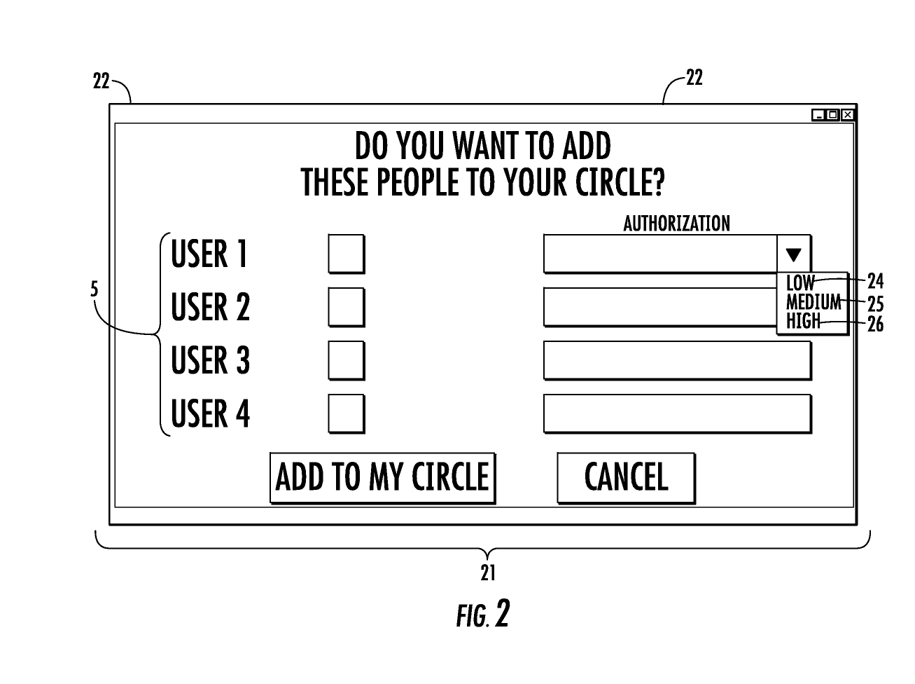

FIG. 3 illustrates an embodiment to determine whether a user should be suggested to a primary user as a member of the primary user's circle based on a common subscriber ID.

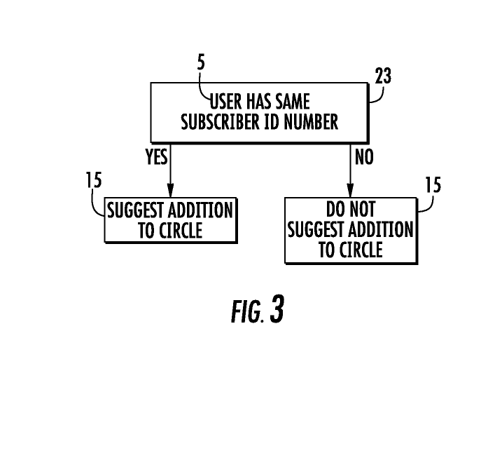

FIG. 4 illustrates an embodiment of a primary user's circle, wherein the primary user's son, wife, and brother are members of his circle, each member of the primary user's circle having differing authorization levels.

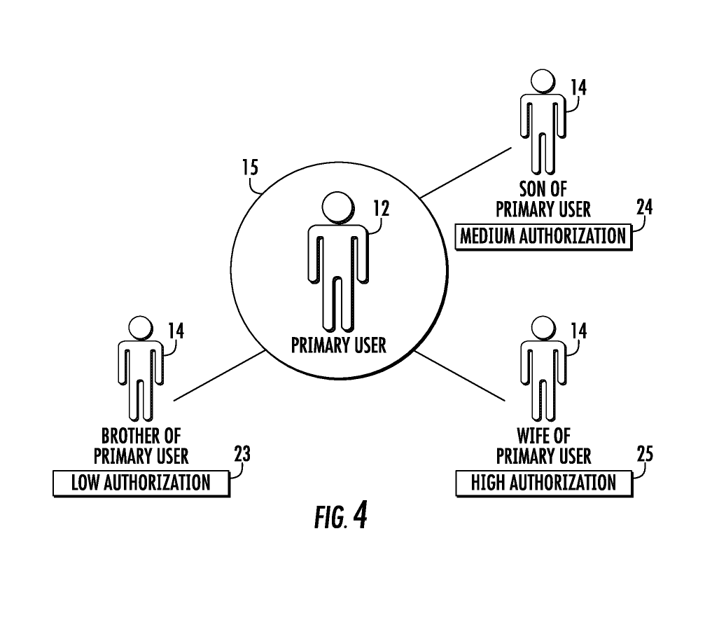

FIG. 5 illustrates an embodiment of the various permissions afforded to members of a primary user's circle based on varying authorization levels.

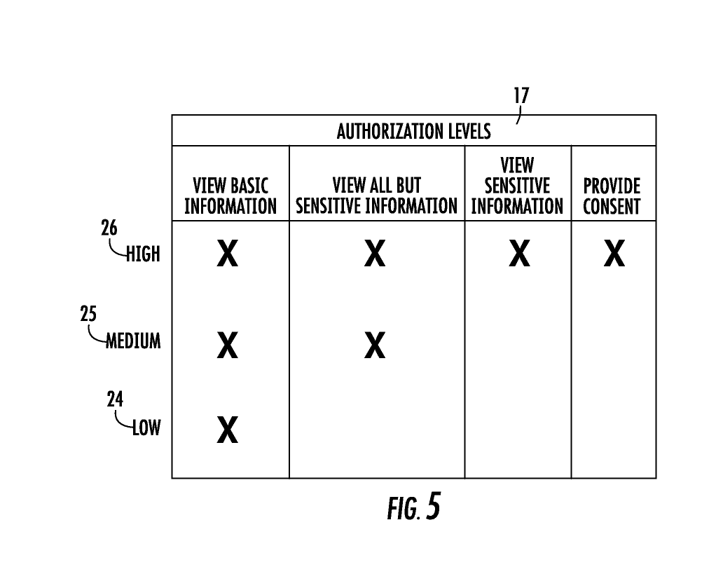

FIG. 6 illustrates an embodiment of a user interface through which a user's identity can be verified by providing a username and password.

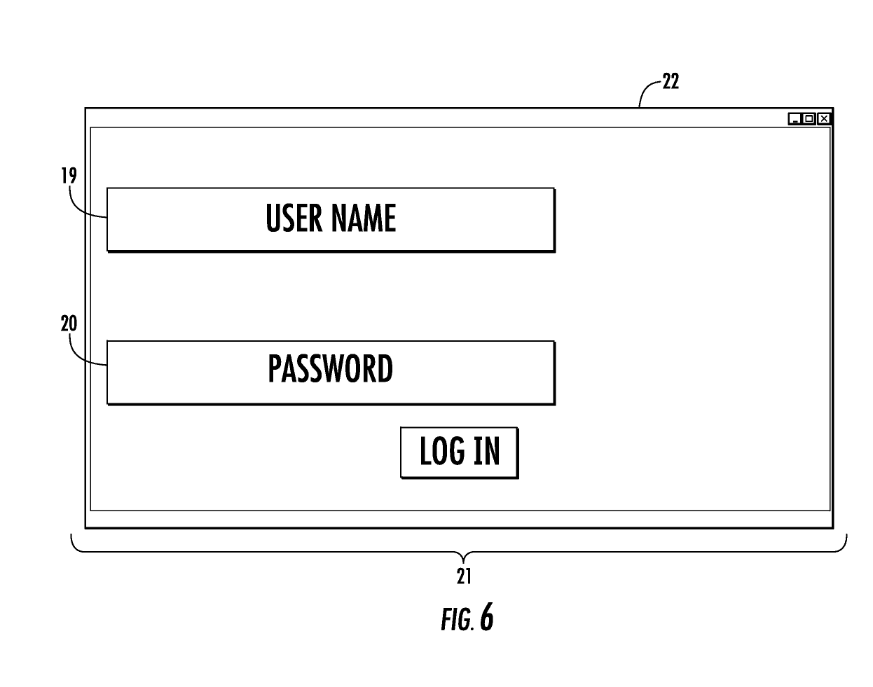

### DETAILED DESCRIPTION

Disclosed is a system 1 and method for selectively sharing information among users of an electronic service wherein the service is used for the storage, retrieval, and transmission of information. In certain embodiments, users share information over one or more internet based applications. The system comprises one or more servers 2, each server coupled to a network. In certain embodiments, one or more servers are coupled to the Internet 3. In certain embodiments, computer readable media 4 encoding instructions for carrying out various methods is coupled to one or more server 2. Users 5 connect to the system servers through various devices 6 having connections to the Internet 3. In alternative embodiments, users may access the system through local area networks, telephonic devices 7, radio frequencies, computers 8, or other electronic devices 9. In certain embodiments, third parties will use the system to store and retrieve information pertaining to users 5. In some embodiments, these third parties 10 may include healthcare providers 11, financial institutions, schools, and social networks.

In certain embodiments, information inputted into the system by third parties 10 will be accessible to users 5, primary users 12, and primary contacts 13. In addition, information inputted into the system 1 will also be accessible to members 14 of a circle 15 associated with an account 16, depending on the member's authorization level 17. In certain embodiments, the system 1 will automatically transmit information to users and members 14 of circles when information is uploaded. Transmission of information to members of circles is limited based on the authorization level held by a given member 14 of a circle 15.

Each user 5 has one or more accounts 16. Associated with each account 16 is various data. Each account has a primary user 12. The data contained on the account 16 pertains to the primary user 12. In healthcare applications, the data on the account may be a primary user's medical information.

Accounts 16 are accessible to users after identity 18 of the user 5 is established. In certain embodiments, users 5 establish their identity by providing a user name 19 and password 20. In alternative embodiments, users may establish their identity by providing other information such as a social security number, credit card number, name, date of birth, mailing address, email address, or a combination of any other information.

Primary users 12 may selectively share information associated with their accounts 16 with other users 5. Each account may be associated with a circle 15. A circle 15 is comprised of one or more other users 5 who are authorized to access information associated with the account 16. Information that may be shared includes information that may be found on social networking websites. Additionally, information of a sensitive nature may also be shared with others in a given circle 15. Medical and health information is of particular relevance.

In a healthcare application, a circle 15 may comprise relatives and close friends of a primary user. These other users 5 may assist the primary user 12 in obtaining proper medical care, reminding the primary user of physician office visits, and be reminded of times when prescription refills are needed. For example, and elderly man may include his two adult children in his circle. By including his adult children in his circle, his adult children will be able to view his medical history, and will be able to actively participate in his healthcare by knowing when his next medical appointments are scheduled, what drugs he is taking, what physicians he is seeing, and what preventative tests he needs. By selectively sharing information with those in a circle 15, medical information can be shared in a secure manner while complying with privacy standards, including the Health Insurance Portability and Accountability Act (HIPAA).

Selective sharing of information occurs when a primary contact 13, elects to allow another user to join his circle. The primary contact 13 may be the primary user 12. Alternatively, the primary contact may be a different user. A primary contact 13 in the circle 15 may be another user 5 when the account is for a child, or an adult who is unable to access information himself.

Through a user interface 21, which may be accessed through a web browser 22 or another software application, the primary contact 13 can add and remove other users 5 to a circle 15. In certain embodiments, the addition of an individual is not reciprocal. In such embodiments, the addition of a user 5 to the circle 15 of account 16 for which the primary contact 13 is acting, does not add the primary contact 13 or the primary user 12 to the circle 15 of the other user 5. In alternative embodiments, the addition of a user to a circle 15 is reciprocal. In such embodiments, an optional requirement is that both users 5 (or the primary contact of a user) agree to be added to each other's circle 15 before the addition will be complete and information will be shared. In certain embodiments, users 5 and primary contacts 13 may be free to add and remove users 5 from their circles at will. When a user is added to a circle 15, the system 1 will notify the user 5 that the user has been added to a circle 15. When a user is added to a circle 15, the user becomes a member of the primary user's circle 15.

When a member 14 of a circle 15 accesses his or her account 16 through a user interface 21, the member 14 is may access information about primary users 12 who have included the member 14 in their circles 15. Depending on authorization level 17, the circle member may then consent to procedures on behalf of primary users, or may communicate with third parties 10 on behalf of the primary user 2. In certain embodiments, a user interface 21 displays all primary users 12 who have accounts 16 that can be viewed by a circle member 14.

In some embodiments, third parties 10 may see who the primary contact 13 is for a given user 5. In healthcare settings, physicians and other healthcare providers may see who the primary contact 13 is for a given user 5. For example, a pediatrician will be able to see who the primary contact is for a child. In most instances, the primary contact 13 for a child will be a parent or guardian. In such embodiments, third parties 10 will also have access to information needed to contact the primary contact such as phone numbers, email addresses, and postal addresses. Certain embodiments also allow third parties, such as healthcare providers, to see others who are members of a given user's circle and the contact information of others in a given circle.

Suggestions are made to users 5 as to possible users 5 who may be desirable to include in a circle 15. Typical suggestions are other users 5 who likely have a close relationship with the primary user 12. In a certain embodiment, the system will prompt a user 5 to add another user to his or her circle 15. This can be done when a user 5 registers for an account 16, or anytime the system 1 detects a potential user meeting certain criteria. The system 1 seeks to prompt users 5 having similar characteristics. In certain embodiments, other users 5 having a common address, phone number, last name, credit card number, or combination thereof will cause the system to suggest a user to add other users having the same characteristics. In certain embodiments particularly applicable to healthcare, the system 1 will prompt a user 5 to add those having the same subscriber ID number 23 (identifying number from a health insurance provider) to the user's circle 15. Commonly, spouses and children will be covered under health plans that provider a single subscriber ID number 23 for all spouses, children, and dependents of the primary insured. In certain embodiments, the system will detect what circles 15 include a user, and prompt the user 5 to add other users 5 who list the user in their circles 15. In other embodiments, the system 1 will prompt users 5 to add those with known relationships to their circles 15. For example, if data stored in the system 1 indicates two users 5 are close relatives, married, or have indicated a close personal relationship exists; the system 1 will prompt users with known relationships to add each other to their circles 15. In certain embodiments in healthcare, this data can be obtained from medical records. In such embodiments, the system will prompt users to add, those who have been listed as emergency contacts, to their circles 15.

In healthcare, and certain other settings, children may have limited or no access to accounts for which they are the primary user 12. In certain embodiments, in cases where children are too young to manage an account independently, the system will automatically place a parent or guardian as the primary contact 13 for the child's account 16. In such embodiments, the child may be granted access to the account 16 when the child reaches a certain age. When the child reaches a specified age and is given full access, the parent, or other primary contact 13, will lose all access to the information contained on the child's account 16. The child may grant access back to a parent, or any other user 5, by adding the parent or other user to the child's circle 15.

Certain embodiments also consider privacy issues in the instance of a divorced couple with children. In such embodiments, when a child's account 16 already has an associated primary contact 13 (typically a parent), no other user 5 may obtain access to the information contained on the account without approval form the primary contact 13. Therefore, in such embodiments, children may be limited to a single primary contact 13 and information will only be shared with others upon approval of the primary contact. In other embodiments, if two subscriber ID numbers 23 are associated with a child's account, and each subscriber ID number 23 is also associated with one parent, each parent having a common subscriber ID number as a child will be able to access the child's account and will be in the child's circle.

When a user is added to a circle 15, the user is assigned an authorization level 17 based on the level of authorization the primary contact wishes to give the specific user. In certain embodiments, there are three levels of authorization levels 17: low 24, medium 25, and high 26. Users 5 in a circle 15 having low 24 authorization are only allowed to view non-sensitive information and are not allowed to make changes to account information or act on behalf of user associated with the account. In certain embodiments used in healthcare, users with low 24 authorization may only view basic information about the user associated with the account 16, and view very limited health information. Users in a circle having medium 25 authorization may view most information on the account 16, but may not make changes to the account information or act on behalf of the primary user. In certain embodiments used in healthcare, users with medium 25 authorization may view all health information except for highly sensitive information such as results of pregnancy tests and diagnoses of sexually transmitted infections. Users in a circle having high 26 authorization may view all information on an account and may make decisions on behalf of the user associated with the account 16. In certain embodiments used in healthcare, users with high authorization may access all medical records and may consent to administration of drugs and major surgery. In accounts where the primary contact is not the user associated with the account, the primary contact is granted high authorization. In some embodiments, the authorized level 17 of a member of a circle may be transmitted to third parties 10. In certain embodiments in healthcare applications, a list of users having high 26 authorization will be transmitted to healthcare providers, thereby enabling healthcare providers to obtain consent for certain procedures from a member of a circle having the appropriate level of authorization 17.

In certain embodiments, when a member 14 of a circle 15 attempts to access a primary user's 12 information, or attempts to act on behalf of a primary user 12, the system will verify the level of authorization of the member of the circle. Verification can be achieved by verifying the level of authorization 17 the primary user selected when adding the member of the circle to the circle.

Among members 14 of a circle 15, information regarding the primary user 12 will be shared with all members of a circle 15. In some embodiments, information will be shared among members of a circle according to their authorized level 17 of access. In such embodiments, those with low 24 access authorization will receive only limited information. In embodiments relating to healthcare, such information may be limited to the primary user's physicians. Those having medium 25 authorization will receive information regarding diagnoses and treatments. Those with high 26 authorization will receive all information relating to the primary user and may be contacted to give consent for certain procedures. Information may be transmitted to members 14 of a circle by email, postal mail, text messaging, or through communication through a user interface, interfacing with the system. Information transmitted to members of a circle 15 may include information pertaining to prescription refills, medical appointments, hospital admissions, diagnostic tests, diagnostic test results, and/or messages from healthcare providers. In some embodiments members 14 of a circle 15 may communicate with a third party 10 on behalf of the primary user 12. In some embodiments, the ability to communicate with a third party 10 may be limited to those having medium 25 authorizations or high 26 authorizations. In embodiments relating to healthcare, communications may be with healthcare providers. Such communication may occur through an interface provided to a member of a primary user's circle through the member's 14 own account 16. Such communication can be in the form of text, transmission of images, or drop-down menus and point-and-click features. Communication with a third party 10 can also grant consent on behalf of the primary user 12. This has particular utility in healthcare settings.

In some embodiments, those with high authorization may give consent and make requests on behalf of the primary user. In embodiments pertaining to healthcare, members of a circle holding high authorization may consent to procedures, request procedures be performed, rescind consent for procedures, order prescription refills, schedule physician visits, and other tasks typically performed by a primary user. It is understood, in such embodiments, that when a primary user gives another user high authorization, that the primary user is providing consent to the user given high authorization to act on behalf of the primary user.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A computer readable media having non-transitory computer readable instructions for carrying out a computerized method for selectively sharing information comprising the steps of:
providing an account to a primary user through a computer network;
providing an account to a second user through the computer network;
obtaining permission from the primary user, to add the second user to a primary user's circle through the computer network;
obtaining permission from the second user, through the computer network, to add the second user to the primary user's circle;
adding the second user to the primary user's circle, thereby making the second user a member of the primary user's circle;
receiving information about the primary user from third parties through the computer network; and
providing information received from third parties to the member of a the primary user's circle through the computer network.

2. The computer readable media having non-transitory computer readable instructions for carrying out a computerized method for selectively sharing information of claim 1 wherein where in information is provided to the member of a primary user's circle through a user interface.

3. The computer readable media having non-transitory computer readable instructions for carrying out a computerized method for selectively sharing information of claim 1 wherein information is provided to a member of a primary user's circle through an email message sent to the member of the primary user's circle.

4. The The computer readable media having non-transitory computer readable instructions for carrying out a computerized method for selectively sharing information of claim 2 further comprising the step of verifying the identity of the member of the primary user's circle.

5. The computer readable media having non-transitory computer readable instructions for carrying out a computerized method for selectively sharing information of claim 4 wherein the identity of the member of the primary user's circle is verified with a username and password combination.

6. The computer readable media having non-transitory computer readable instructions for carrying out a computerized method for selectively sharing information of claim 4 wherein access to the information obtained from third parties about the primary user is restricted by authorization level.

7. The computer readable media having non-transitory computer readable instructions for carrying out a computerized method for selectively sharing information of claim 4 wherein the non-transitory computer readable insturctions for carrying out a computerizedmethod for selectively sharing information further comprise the step of verifying an authorization level of a member of the primary user's circle.

8. The computer readable media having non-transitory computer readable instructions for carrying out a computerized method for selectively sharing information of claim 7 wherein the non-transitory computer readable insturctions for carrying out a computerizedmethod for selectively sharing information further comprise the steps of:
verifying the authorization level of a member of the primary user's circle is high; and
receiving consent for a medical procedure from the member of the primary user's circle through the computer network.

9. A computerized method for selectively sharing information comprising the steps of:
suggesting, through a computer network, one or more second users who likely have a close relationship with a primary user as potential members of the primary user's circle based on the one or more second users satisfying one or more criteria, said one or more criteria selected from the group consisting of sharing a common address with the primary user, sharing a common phone number with the primary user, sharing a common last name with the primary user, sharing a common credit card number with the primary user, sharing a common subscriber ID number with the primary user, having a known relationship with the primary user, and the primary user already being a member of the one or more second users' circles;
determining a suggested second user is a child of the primary user; and
assigning an authorization level for the primary user as high with respect to information pertaining to the second user.

10. The computerized method for selectively sharing information of claim 9 further comprising the step of displaying the primary user's parent status to the second user's healthcare provider.

11. The computerized method for selectively sharing information of claim 9 furher comprising the step of displaying the second user's health information to the primary user over a computer network.

12. The computerized method for selectively sharing information of claim 9 furher comprising the step of obtaining consent from the primary user, over a computer network, for a medical procedure to be performed on the second user.
